(19) United States
(12) Patent Application Publication
(10) Pub. No.: US 2026/0301577 A1
(43) Pub. Date: Oct. 1, 2026

(54) Pedestrian Alert Signal System

(71) Applicants: Stacy Johnson Allen, South Jordan, UT (US); Blake William Allen, South Jordan, UT (US)

(72) Inventors: Stacy Johnson Allen, South Jordan, UT (US); Blake William Allen, South Jordan, UT (US)

(21) Appl. No.: 19/635,148

(22) Filed: Mar. 31, 2026

Related U.S. Application Data
(60) Provisional application No. 63/781,299, filed on Mar. 31, 2025.

(51) Int. Cl. G08G 1/16; G08G 1/07; H05B 47/105

(52) U.S. Cl. CPC G08G 1/166; G08G 1/07; H05B 47/105

(57) ABSTRACT

A pedestrian alert signal system may include a pedestrian detector and a blank-out sign communicatively coupled to the pedestrian detector. The blank-out sign may be configured to display a pedestrian symbol and one or more directional crosswalk indicators positioned adjacent to the pedestrian symbol in response to receiving an indication of pedestrian detection from the pedestrian detector. The pedestrian alert signal system may include a communication module, a processor, and a memory. The memory may store instructions that, when executed by the processor, cause the processor to send the indication of pedestrian detection from the pedestrian detector to the blank-out sign using the communication module.

### CROSS REFERENCE TO RELATED APPLICATION

This application claims the benefit of and priority to U.S. Provisional Application No. 63/781,299 filed Mar. 31, 2025, which is incorporated herein by reference in its entirety.

### FIELD

The present disclosure generally relates to a pedestrian alert signal system.

### BACKGROUND

Vehicle-pedestrian collisions are a public safety concern. According to data from the U.S. Federal Highway Administration, 983 pedestrians were killed at signalized intersections in the United States in 2022. Vehicle driver inattention to pedestrians in or near crosswalks may be a contributing factor to vehicle-pedestrian collisions. Drivers may not consistently stop at signalized intersections to check for pedestrians, particularly during turning maneuvers, even when a pedestrian traffic signal may be indicating a street crossing phase for pedestrians.

The subject matter claimed in the present disclosure is not limited to embodiments that solve any disadvantages or that operate only in environments such as those described above. Rather, this background is only provided to illustrate example technology areas where some embodiments described in the present disclosure may be practiced.

### SUMMARY

In accordance with one or more embodiments of the present disclosure, a pedestrian alert signal system may include a pedestrian detector and a blank-out sign communicatively coupled to the pedestrian detector. The blank-out sign may be configured to display, in response to receiving an indication of pedestrian detection from the pedestrian detector, a pedestrian symbol and one or more directional crosswalk indicators positioned adjacent to the pedestrian symbol.

In accordance with one or more additional embodiments of the present disclosure, a pedestrian alert apparatus may include a housing configured to couple to a traffic signal support structure. The pedestrian alert apparatus may include a display panel disposed within the housing configured to generate, in response to receiving an indication of pedestrian detection, a pedestrian symbol and one or more directional crosswalk indicators. The pedestrian alert apparatus may include a control interface configured to control generation of the pedestrian symbol and the one or more directional crosswalk indicators in response to receiving an indication of pedestrian detection.

In accordance with one or more additional embodiments of the present disclosure, a method may include receiving an indication of pedestrian detection from a pedestrian detector and generating, in response to the indication of pedestrian detection, one or more directional crosswalk indicators of a pedestrian alert apparatus coupled to a traffic signal support structure.

The objects and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example operating environment for a pedestrian alert signal system;

FIG. 2 illustrates an example pedestrian alert apparatus;

FIG. 3 illustrates a flowchart of an example method of pedestrian alert signaling; and

FIG. 4 illustrates an example computing system, all in accordance with one or more embodiments of the present disclosure.

### DETAILED DESCRIPTION

Pedestrians may face safety risks when crossing streets where vehicular traffic may also be present. Although signalized intersections may facilitate the orderly movement of vehicles and pedestrians, incidents between vehicles and pedestrians, such as vehicle-pedestrian collisions, may occur. Such incidents may result from, or be exacerbated by, driver inattention to pedestrian street crossing activity. For example, drivers may be unaware of the presence of pedestrians in or near one or more crosswalks. Automatically providing drivers with visual information corresponding to pedestrian street crossing activity may reduce the likelihood of vehicle-pedestrian incidents and increase pedestrian safety.

As used herein, a “pedestrian” may refer to any person on foot, walking, running, jogging, hiking, sitting, or lying down. Additionally or alternatively, “pedestrian” may include any person on a bicycle, unicycle, scooter, wheelchair, or other personal mobility device when present within a crosswalk, on a sidewalk, or when crossing a road. As used herein, a “vehicle” may refer to any motor vehicle. Additionally or alternatively, “vehicle” may refer to any bicycle, unicycle, scooter, wheelchair, or other personal mobility device when present within a travel lane. As used herein, the terms “driver” and “vehicle driver” may refer to a person operating a vehicle (e.g., a motor vehicle driver, a bicyclist, a unicyclist, a scooter rider, a person traveling by wheelchair, or a person traveling by another personal mobility device).

Traditional approaches to alerting drivers about pedestrians may include static signs such as signage including the phrase “Yield to Pedestrians” or one or more similar phrases. Pavement markings may be another traditional approach used to alert drivers about pedestrians such as by designating crosswalk boundaries and/or including words or phrases (e.g., “YIELD”, “PED XING”, etc.). Such traditional approaches may fail to draw attention from drivers at times when pedestrian street crossing activity is present. For example, static signs and pavement markings may become viewed as part of the background visual environment over time, such that drivers may habituate to their presence, a phenomenon known as sign fatigue.

Traffic control devices, such as vehicular traffic signals and pedestrian traffic signals, may not display information indicating pedestrian detection and/or pedestrian location. For example, pedestrian traffic signals may include a set of signals at intersections and/or crosswalks configured to indicate to pedestrians when a street may be safe to cross. Such pedestrian traffic signals may display a walk signal (e.g., white walking figure symbol) that may be configured to indicate when pedestrians should cross a street, a flashing do not walk signal (e.g., a flashing orange hand) that may be configured to indicate that pedestrians currently crossing a street should continue to complete crossing but no new pedestrians should begin crossing, a steady do not walk signal (e.g., a solid orange hand) that may be configured to indicate that pedestrians should not cross a street as vehicular cross traffic has the right of way, and/or a countdown timer that may be configured to indicate the number of seconds remaining before a vehicular traffic signal changes. However, pedestrian traffic signals may not include information about pedestrian detection (e.g., the walk signal may be displayed even when no pedestrian is present) and/or about pedestrian location (e.g., pedestrian traffic signals on both the east side and west side of a street may be displaying walk signals but the walk signal does not indicate that a pedestrian is present on the east side while there is no pedestrian on the west side).

The present disclosure may relate to, among other things, a pedestrian alert signal system, apparatus, and method to alert vehicle drivers of pedestrian detection and pedestrian location. Displaying information about pedestrian detection and pedestrian location may increase driver attention to pedestrian street crossing activity. Thus, the disclosed pedestrian alert signal system, apparatus, and method herein may reduce vehicle-pedestrian collisions from occurring.

Embodiments of the present disclosure are explained with reference to the accompanying figures. It is to be understood that the figures are diagrammatic and schematic representations of such example embodiments, and are not limiting of the present disclosure, nor are they necessarily drawn to scale.

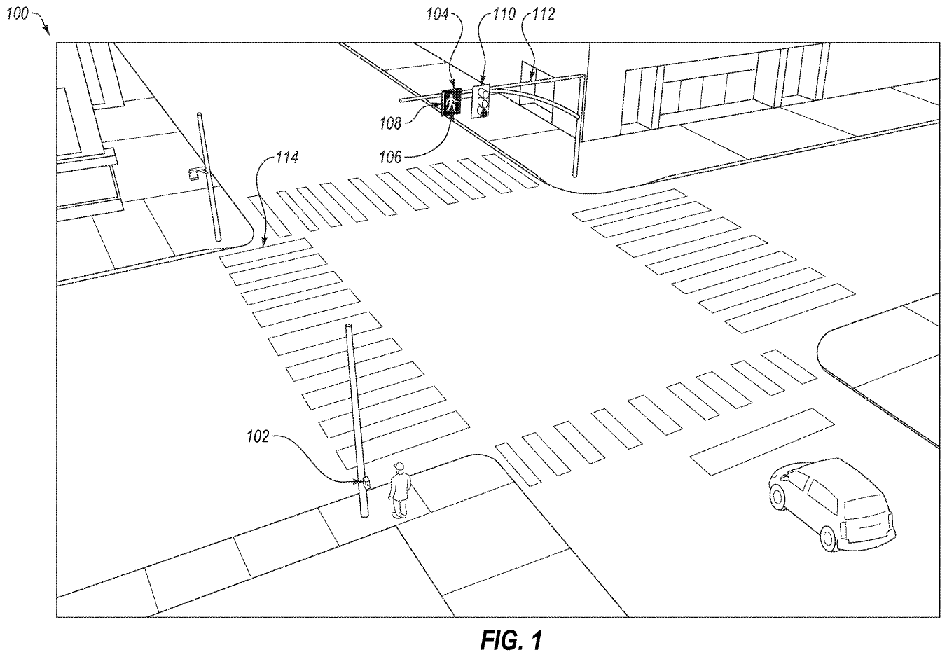

FIG. 1 illustrates an example operating environment 100 (hereinafter “the environment 100”) of a pedestrian alert signal system including a pedestrian detector 102 and a pedestrian alert apparatus 104, in accordance with one or more embodiments of the present disclosure. The environment 100 may include a vehicular traffic signal 110, a traffic signal support structure 112, and/or a crosswalk 114. In some embodiments, the vehicular traffic signal 110 may be a traffic light. The vehicular traffic signal 110 may be configured to display vehicular traffic control indications (e.g., red, yellow, and green signals). In some embodiments, the traffic signal support structure 112 may include a vertical pole and a horizontal mast arm extending from the vertical pole such that the pedestrian alert apparatus 104 and/or the vehicular traffic signal 110 may be coupled to the horizontal mast arm. For example, the pedestrian alert apparatus 104 may be positioned adjacent to the vehicular traffic signal 110 on the traffic signal support structure 112. In some embodiments, the pedestrian alert apparatus 104 may be coupled to the traffic signal support structure 112 using one or more mounting brackets, clamps, and/or fasteners. The crosswalk 114 may include one or more pavement markings on a street (e.g., to indicate an area intended for pedestrian cross activity). For example, the crosswalk 114 may include parallel lines or stripes. In some embodiments, the crosswalk 114 may include an unmarked crosswalk (e.g., a crosswalk without paint or lines). Although the environment 100 is depicted as including a single crosswalk (e.g., the crosswalk 114), the environment 100 may include multiple crosswalks.

In some embodiments, the environment 100 may correspond to a signalized intersection, a mid-block street crossing, or any other roadway location. The environment 100 may include one or more streets, vehicles, pedestrian areas (e.g., sidewalks), and/or pedestrians. For example, as illustrated in FIG. 1, a pedestrian may be located on a sidewalk near the crosswalk 114 and a vehicle may be located on a street such that a driver may be able to see the pedestrian alert apparatus 104 coupled to the traffic signal support structure 112 (e.g., while the driver is looking at, or towards, the vehicular traffic signal 110).

In some embodiments, the pedestrian detector 102 may be configured to detect one or more pedestrians in the environment 100. For example, the pedestrian detector 102 may detect a pedestrian approaching, waiting at, entering, or occupying one or more crosswalks (e.g., the crosswalk 114). In some embodiments, the pedestrian detector 102 may be positioned on, in, or near a street, sidewalk, street curb, curb ramp, and/or pedestrian refuge. The pedestrian detector 102 may be powered using one or more power sources corresponding to the vehicular traffic signal 110 and/or to one or more pedestrian traffic signals that may be included in the environment 100. Additionally or alternatively, the pedestrian detector 102 may be powered using one or more local power sources such as batteries, solar panels, etc. coupled to or integrated with the pedestrian detector 102.

The pedestrian detector 102 may include one or more devices configured to generate an indication of pedestrian detection. In some embodiments, the pedestrian detector 102 may include a pedestrian push button (e.g., a button configured to be pushed by a pedestrian to request a street crossing phase). Additionally or alternatively, the pedestrian detector 102 may include a passive pedestrian detection device configured to detect pedestrian presence, motion, and/or location without manual activation. For example, the pedestrian detector 102 may include an image sensor, infrared camera, microwave radar, piezoelectric pressure mat, and/or a light detection and ranging (LiDAR) sensor. In some embodiments, the pedestrian detector 102 may be communicatively coupled to a pedestrian walk signal (e.g., the pedestrian detector 102 may be the same as a pedestrian push button configured to communicate with a pedestrian walk signal present in the environment 100).

In some embodiments, the pedestrian detector 102 may be communicatively coupled to the pedestrian alert apparatus 104. In these and other embodiments, the pedestrian alert apparatus 104 may be configured to display, in response to receiving an indication of pedestrian detection from the pedestrian detector 102, a pedestrian symbol 106 and/or one or more directional crosswalk indicators (e.g., the directional crosswalk indicator 108) positioned adjacent to the pedestrian symbol 106.

In some embodiments, the pedestrian alert apparatus 104 may include a blank-out sign. For example, the pedestrian alert apparatus 104 may include a blank-out sign configured to remain blank or non-illuminated until an indication of pedestrian detection from the pedestrian detector 102 is received. In some embodiments, the blank-out sign may be configured to reduce visual clutter and/or sign fatigue experienced by drivers. In these and other embodiments, the blank-out sign may include a light-emitting diode (LED) array configured to generate the pedestrian symbol 106 and/or one or more directional crosswalk indicators (e.g., directional crosswalk indicator 108).

In some embodiments, the pedestrian symbol 106 may include a walking person icon or one or more other icons, shapes, lines, etc. In these and other embodiments, the pedestrian symbol 106 may be animated.

In some embodiments, the one or more directional crosswalk indicators may include a top indicator, a bottom indicator, a left indicator, and/or a right indicator positioned relative to the pedestrian symbol 106. For example, an intersection with a four-way stop for vehicular traffic may include four crosswalks such that each of the directional crosswalk indicators may correspond to one of the crosswalks in the intersection. In some embodiments, the positioning of the directional crosswalk indicators relative to the pedestrian symbol 106 may be configured to correspond to the viewpoint of approaching drivers. For example, the bottom indicator may include a lighted horizontal line below the pedestrian symbol 106 and/or near the bottom portion of the blank-out sign such that the bottom indicator may be configured to indicate to a driver that a pedestrian is crossing at the crosswalk nearest to the driver (e.g., in front of the driver). Although the directional crosswalk indicator 108 is depicted as a solid line, in some embodiments, the directional crosswalk indicators may include dashed lines and/or any other type of line, shape, or icon. For example, the directional crosswalk indicators may include one or more crosswalk symbols.

In some embodiments, the directional crosswalk indicators may display pedestrian location information to drivers. For example, a bottom indicator may indicate that a pedestrian is in a crosswalk nearest to the driver, a top indicator may indicate that a pedestrian is in a crosswalk farthest from the driver or opposite the driver's position, a left indicator may indicate that a pedestrian is in a crosswalk to the driver's left, and/or a right indicator may indicate that a pedestrian is in a crosswalk to the driver's right. In some embodiments, multiple of the directional crosswalk indicators may be illuminated simultaneously when pedestrians are present at multiple crosswalks. In these and other embodiments, the directional crosswalk indicators may assist drivers in distinguishing between pedestrian activity occurring in different crosswalks in response to multiple pedestrian street crossings occurring concurrently.

In some embodiments, the blank-out sign (e.g., the pedestrian alert apparatus 104) may include a control system configured to selectively activate individual directional crosswalk indicators to indicate one or more crosswalks with pedestrian street crossing activity based on the indication of pedestrian detection from the pedestrian detector 102. In these and other embodiments, the control system may include a central processing unit (CPU) and one or more controllers (e.g., a hardware chip, circuit board, software device, etc.) configured to manage, translate, and/or direct data flow between the pedestrian alert apparatus 104 and one or more other devices in the environment 100. For example, the control system may be configured to coordinate between the pedestrian alert apparatus 104 and the pedestrian detector 102 such that when the pedestrian detector 102 detects the pedestrian, the control system may trigger the pedestrian alert apparatus 104 to display the pedestrian symbol 106 and the directional crosswalk indicator 108.

In some embodiments, the pedestrian alert signal system (e.g., the pedestrian detector 102 and the pedestrian alert apparatus 104) may be communicatively coupled to a traffic signal controller configured to control timing of the vehicular traffic signal 110. For example, when the pedestrian detector 102 of the pedestrian alert signal system generates an indication of pedestrian presence, the traffic signal controller may be configured to control the timing of the vehicular traffic signal 110 such that the vehicular traffic signal 110 may turn red (e.g., after a predetermined amount of time following the generation of the indication of pedestrian presence).

In some embodiments, the pedestrian alert apparatus 104 may be configured to be visible to drivers in vehicles approaching or stopped at the intersection. In some embodiments, the pedestrian alert apparatus 104 may be positioned such that the pedestrian alert apparatus 104 may be visible to a driver in the driver's normal field of view while monitoring the vehicular traffic signal 110. For example, the pedestrian alert apparatus 104 may be positioned adjacent to or between the vehicular traffic signal 110 coupled to the traffic signal support structure 112.

In some embodiments, the pedestrian detector 102 and/or the pedestrian alert apparatus 104 may be one of multiple pedestrian detectors and/or pedestrian alert apparatuses of a pedestrian alert signal system that may be implemented in the environment 100. For example, multiple pedestrian detectors and multiple pedestrian alert apparatuses may be positioned at different locations around an intersection.

As an example of operation of the pedestrian alert signal system, a pedestrian may be present on a sidewalk or pedestrian area adjacent to the crosswalk 114. The pedestrian detector 102 may detect the pedestrian relative to the crosswalk 114 and may generate an indication of pedestrian detection. In response to receiving the indication of pedestrian detection from the pedestrian detector 102, the pedestrian alert apparatus 104 may display the pedestrian symbol 106 and the directional crosswalk indicator 108. The pedestrian alert apparatus 104 may be positioned to be visible to a driver in a vehicle looking forward at the vehicular traffic signal 110. The directional crosswalk indicator 108 being a left indicator (e.g., adjacent to the pedestrian symbol 106 on the left side of the pedestrian symbol 106) may indicate that the pedestrian is located in or near a crosswalk positioned to the left of the vehicle.

Modifications, additions, or omissions may be made to the environment 100 without departing from the scope of the present disclosure. For example, in some embodiments, the environment 100 may include any number of other components that may not be explicitly illustrated or described. Further, the environment 100 may include other systems and/or apparatuses than those illustrated or described.

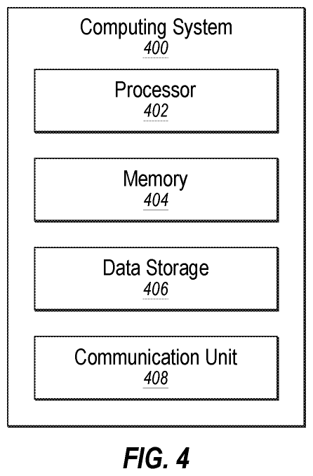

For example, in some embodiments, the pedestrian alert signal system operating in the environment 100 may include a communication module, a processor, and/or a memory. The communication module may include code and routines. In some embodiments, the communication module may be implemented using hardware including one or more processors, central processing units, graphics processing units, data processing units, parallel processing units, microprocessors, field-programmable gate arrays, application-specific integrated circuits, accelerators, one or more programmable vision accelerators, which may include one or more vector processing units, one or more direct memory access systems, one or more pixel processing engines, and/or other processor types. In these and other embodiments, the communication module may be implemented using a combination of hardware and software. In some embodiments, operations described as being performed by the communication module may include operations that the communication module may direct one or more corresponding computing systems to perform. The communication module may be configured to perform a series of operations with respect to the pedestrian detector 102, the pedestrian alert apparatus 104, and/or the vehicular traffic signal 110. In these and other embodiments, the communication module may be implemented by one or more computing systems, such as the computing system 400 described below with respect to FIG. 4. In some embodiments, the memory of the pedestrian alert signal system may store instructions that, when executed by the processor, cause the processor to send the indication of pedestrian detection from the pedestrian detector 102 to the blank-out sign (e.g., the pedestrian alert apparatus 104) using the communication module.

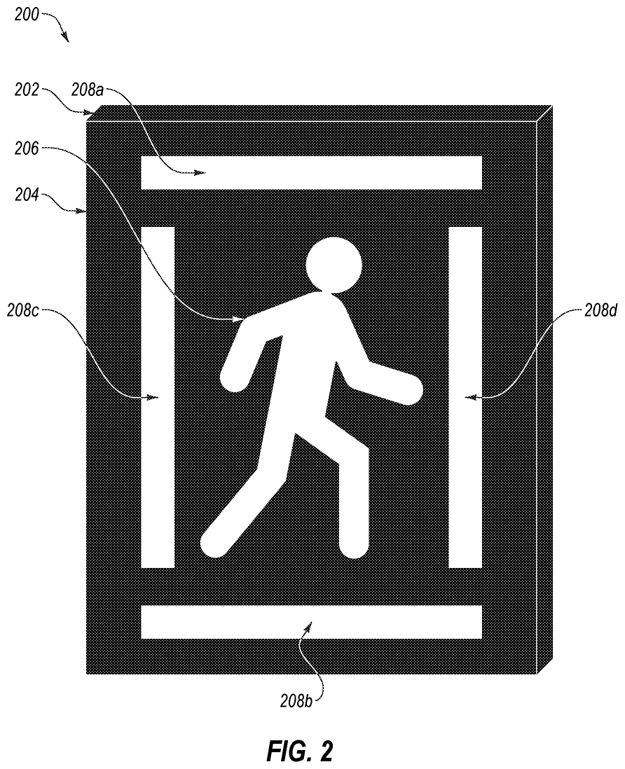

FIG. 2 illustrates an example pedestrian alert apparatus 200 (hereinafter “pedestrian alert apparatus 200”), in accordance with one or more embodiments of the present disclosure. In some embodiments, the pedestrian alert apparatus 200 may be the same as or similar to the pedestrian alert apparatus 104 described above with respect to FIG. 1. For example, the pedestrian alert apparatus 200 may be, or may include, a blank-out sign.

In some embodiments, the pedestrian alert apparatus 200 may include a housing 202 and a display panel 204. The housing 202 may be configured to provide structural support and/or environmental protection for one or more internal components of the pedestrian alert apparatus 200. In some embodiments, the housing 202 may be formed from polycarbonate (e.g., molded polycarbonate resin), aluminum (e.g., die cast aluminum), stainless steel, and/or any other material. In some embodiments, the housing 202 may be configured for outdoor use and/or prolonged exposure to environmental conditions. The housing 202 may include a mounting feature configured to couple the pedestrian alert apparatus 200 to a traffic signal support structure such as the traffic signal support structure 112 described above with respect to FIG. 1. The housing 202 may be dimensioned to accommodate the display panel 204.

In some embodiments, the display panel 204 may be disposed within the housing 202. The display panel 204 may be configured to generate a pedestrian symbol 206 and/or one or more of a top directional crosswalk indicator 208a, a bottom directional crosswalk indicator 208b, a left directional crosswalk indicator 208c, and a right directional crosswalk indicator 208d (collectively, “the directional crosswalk indicators 208”). In some embodiments, the pedestrian symbol 206 may include a walking person icon or one or more other icons, shapes, lines, etc. For example, the pedestrian symbol 206 may be configured to depict an outline of a human figure in a walking pose. In these and other embodiments, the pedestrian symbol 206 may have a height and/or width ranging from approximately 6 inches (15.24 centimeters) to approximately 24 inches (60.96 centimeters). In some embodiments, the directional crosswalk indicators 208 may each include one or more icons, shapes, lines, etc. (e.g., a solid line, a dashed line, a rectangle, and/or stripes) positioned to visually indicate a corresponding crosswalk. In these and other embodiments, the directional crosswalk indicators 208 may each have a height and/or width ranging from approximately 3 inches (7.62 centimeters) to approximately 12 inches (30.48 centimeters). The directional crosswalk indicators 208 may be positioned adjacent to the pedestrian symbol 206 such that the directional crosswalk indicators 208 may be positioned at distances ranging from approximately 1 inch (2.54 centimeters) to approximately 6 inches (15.24 centimeters) from the pedestrian symbol 206 (e.g., one directional crosswalk indicator on each of four sides-above, below, left, and right-of the pedestrian symbol 206). In some embodiments, the pedestrian symbol 206 and/or the directional crosswalk indicators 208 may be sized to provide visibility to vehicle drivers at distances ranging from approximately 100 feet (30.48 meters) to approximately 500 feet (152.40 meters) away from the pedestrian alert apparatus 200.

In some embodiments, the display panel 204 may be configured to generate the pedestrian symbol 206 and/or the directional crosswalk indicators 208 in response to receiving an indication of pedestrian detection. The display panel 204 may receive the indication of pedestrian detection from one or more of a pedestrian push button and a passive pedestrian detection device. For example, the display panel 204 may receive the indication of pedestrian detection from an image sensor, an infrared camera, a microwave radar, a piezoelectric pressure mat, and/or a LiDAR sensor. For instance, a LiDAR sensor may be positioned adjacent to a crosswalk and configured to emit laser pulses toward one or more detection zones. The LiDAR sensor may be configured to measure time-of-flight of reflected laser pulses to determine pedestrian presence and/or location within a detection zone (e.g., by identifying three-dimensional point clouds corresponding to human forms when one or more pedestrians are present). In response to detecting one or more pedestrians, the LiDAR sensor may be configured to generate the indication of pedestrian detection (e.g., send out a signal including the indication of pedestrian detection).

In some embodiments, the pedestrian alert apparatus 200 may include a control interface configured to control generation of the pedestrian symbol 206 and the directional crosswalk indicators 208 in response to receiving the indication of pedestrian detection. The control interface may include one or more input terminals configured to receive signals from one or more pedestrian detectors (e.g., the pedestrian detector 102 described above with respect to FIG. 1). In some embodiments, the control interface may include a logic circuit, a microcontroller, and/or a programmable controller configured to process signals and selectively activate portions of the display panel 204. In these and other embodiments, the control interface may include a communication module configured for wired and/or wireless communication between the control interface and one or more external devices (e.g., communication between the pedestrian alert apparatus 200 and pedestrian detectors, vehicular traffic signals, and/or pedestrian traffic signals).

In some embodiments, the display panel 204 may include an LED array corresponding to the pedestrian symbol 206 and/or the directional crosswalk indicators 208. The LED array may include multiple individual LEDs arranged in a matrix configuration. In some embodiments, the LED array may be configured to selectively illuminate individual LEDs and/or groups of LEDs to generate the pedestrian symbol 206 and/or the directional crosswalk indicators 208. The LED array may be configured to emit light in one or more colors. For example, the LED array may be configured to emit white light, yellow light, red light, and/or any other color of light. In some embodiments, the LED array may be configured to permit the pedestrian symbol 206 and/or the directional crosswalk indicators 208 to be animated (e.g., the pedestrian symbol 206 may be generated using selectively illuminated individual LEDs in the LED array such that the pedestrian symbol 206 may appear to be walking). In these and other embodiments, animating the pedestrian symbol 206 and/or the directional crosswalk indicators 208 using the LED array may increase visibility and/or detection of the pedestrian alert apparatus 200 by one or more vehicle drivers.

In some embodiments, the pedestrian alert apparatus 200 may be communicatively coupled to a traffic signal controller configured to control timing of a vehicular traffic signal. The pedestrian alert apparatus 200 may be configured to exchange data with the traffic signal controller to coordinate display timing of the display panel 204 with vehicular traffic signal phases. In some embodiments, communicatively coupled may include the pedestrian alert apparatus 200 and the traffic signal controller being configured for wired communication, wireless communication, and/or any combination of wired and wireless communication. For example, communicatively coupled may include communication via one or more of a hardwired electrical connection, a fiber optic connection, an internet connection, a radio frequency connection, etc. In some embodiments, the pedestrian alert apparatus 200 may be configured to coordinate generation of the pedestrian symbol 206 and/or the directional crosswalk indicators 208 with pedestrian crossing phases controlled by the traffic signal controller.

Modifications, additions, or omissions may be made to the pedestrian alert apparatus 200 without departing from the scope of the present disclosure. For example, in some embodiments, the pedestrian alert apparatus 200 may include any number of other components that may not be explicitly illustrated or described. Further, the pedestrian alert apparatus 200 may be included in other systems and/or contexts than those illustrated or described.

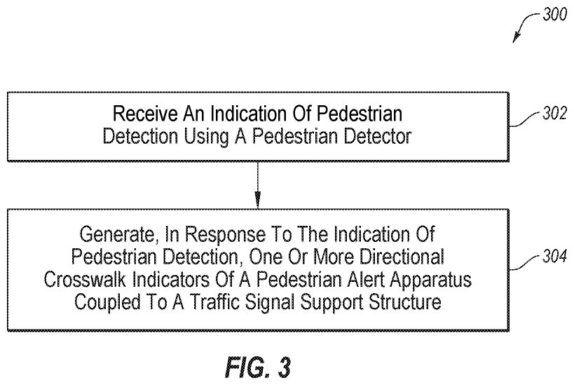

FIG. 3 illustrates a flowchart of an example method (hereinafter “the method 300”) of pedestrian alert signaling, in accordance with one or more embodiments of the present disclosure. The method 300 may be performed by any suitable system, apparatus, or device. For example, the method 300 may be implemented in the environment 100 of FIG. 1 and/or by one or more apparatuses/systems described with respect to FIGS. 1 and 2. Additionally or alternatively, one or more operations of the method 300 may be performed by a computing system, such as the computing system 400 described below with respect to FIG. 4. Although illustrated with discrete blocks, the steps and operations associated with one or more blocks of the method 300 may be divided into additional blocks, combined into fewer blocks, or eliminated, depending on the particular implementation. In some embodiments, one or more non-transitory computer readable mediums may be configured to store instructions that when executed result in performing the method 300.

The method 300 may include block 302. At block 302, an indication of pedestrian detection may be received from a pedestrian detector. The pedestrian detector 102 described above with respect to FIG. 1 may be an example of the pedestrian detector. In some embodiments, receiving the indication of pedestrian detection using the pedestrian detector may include pushing of a pedestrian push button. Additionally or alternatively, receiving the indication of pedestrian detection using the pedestrian detector may include detecting pedestrian presence without manual activation by a pedestrian. For example, receiving the indication of pedestrian detection may include image sensing, thermal sensing, microwave radar sensing, pressure sensing, and/or LiDAR sensing. In some embodiments, receiving the indication of pedestrian detection may include processing sensor data to identify pedestrians. For example, receiving the indication of pedestrian detection may include analyzing one or more images (e.g., captured by a camera) using one or more computer vision techniques to identify human forms included in the images. In some embodiments, receiving the indication of pedestrian detection may include receiving the indication of pedestrian detection wirelessly via a communication module. For example, a pedestrian detector may transmit the indication of pedestrian detection to a pedestrian alert apparatus via radio frequency, Bluetooth®, WiFi, a cellular network, etc.

At block 304, one or more directional crosswalk indicators of a pedestrian alert apparatus coupled to a traffic signal support structure may be generated based on the indication of pedestrian presence. The pedestrian alert apparatus 104 described above with respect to FIG. 1 and/or the pedestrian alert apparatus 200 described above with respect to FIG. 2 may be examples of the pedestrian alert apparatus. In some embodiments, generating the directional crosswalk indicators may include determining which crosswalks in an environment (e.g., an intersection) include one or more pedestrians. For example, generating the directional crosswalk indicators may include receiving location data (e.g., location data included in the indication of pedestrian presence) indicating which pedestrian detectors may have detected pedestrians near or in crosswalks. For instance, when a pedestrian is detected waiting to cross a crosswalk located to the left of the pedestrian alert apparatus, the left indicator of the directional crosswalk indicators may be generated. In some embodiments, the pedestrian alert apparatus may be positioned adjacent to a vehicular traffic signal coupled to a traffic signal support structure (e.g., a horizontal mast arm). For example, the pedestrian alert apparatus may be positioned to the left or the right of a traffic light or positioned between two traffic lights. Additionally or alternatively, the pedestrian alert apparatus may be positioned above or below one or more vehicular traffic signals. In some embodiments, the pedestrian alert apparatus may be positioned relative to one or more signs (e.g., “No Right Turn on Red” signs, “Yield to Pedestrians” signs, “No U Turn” signs, etc.). In some embodiments, generating the directional crosswalk indicators may include illuminating an LED array (e.g., emitting light from one or more individual LEDs in an LED array). In these and other embodiments, generating the directional crosswalk indicators may include controlling brightness levels of the LEDs based on detected and/or predicted ambient light conditions. For example, generating the directional crosswalk indicators may include increasing the brightness of light emitted from the LED array during bright/sunny conditions and/or during expected daylight hours compared to the brightness of light emitted from the LED array during dark/overcast conditions and/or during expected nighttime hours.

Modifications, additions, or omissions may be made to the method 300 without departing from the scope of the present disclosure. For example, in some embodiments, the method 300 may include any number of other steps that may not be explicitly illustrated or described. For instance, the method 300 may include communicating with a traffic signal controller to coordinate timing of generating the one or more directional crosswalk indicators with timing of the vehicular traffic signal. In some embodiments, the method 300 may include displaying a pedestrian symbol adjacent to the one or more directional crosswalk indicators. The method 300 may be implemented in other systems and/or contexts than those described.

FIG. 4 is an example computing system 400, arranged in accordance with at least some embodiments of the present disclosure. The computing system 400 may include a processor 402, a memory 404, a data storage 406, and/or a communication unit 408, which all or one or more of may be communicatively coupled. For example, the pedestrian detector 102, the pedestrian alert apparatus 104, and/or the vehicular traffic signal in the environment 100 described above with respect to FIG. 1 and/or the pedestrian alert apparatus 200 described above with respect to FIG. 2 may be implemented as or configured to utilized a computing system consistent with the computing system 400.

Generally, the processor 402 may include any suitable special-purpose or general-purpose computer, computing entity, or processing device including various computer hardware or software modules and may be configured to execute instructions stored on any applicable computer-readable storage media. For example, the processor 402 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 4, it is understood that the processor 402 may include any number of processors distributed across any number of network or physical locations that are configured to perform individually or collectively any number of operations described in the present disclosure. In some embodiments, the processor 402 may interpret and/or execute program instructions and/or process data stored in the memory 404, the data storage 406, or the memory 404 and the data storage 406. In some embodiments, the processor 402 may fetch program instructions from the data storage 406 and load the program instructions into the memory 404.

After the program instructions are loaded into the memory 404, the processor 402 may execute the program instructions, such as instructions to cause the computing system 400 to perform some or all of the operations of the method 300 described above with respect to FIG. 3. For example, the computing system 400 may execute the program instructions to receive an indication of pedestrian detection using a pedestrian detector and/or to generate, in response to the indication of pedestrian detection, one or more directional crosswalk indicators of a pedestrian alert apparatus coupled to a traffic signal support structure.

The memory 404 and the data storage 406 may include computer-readable storage media or one or more computer-readable storage mediums for having computer-executable instructions or data structures stored thereon. Such computer-readable storage media may be any available media that may be accessed by a general-purpose or special-purpose computer, such as the processor 402. In some embodiments, the computing system 400 may or may not include either of the memory 404 and the data storage 406.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 402 to perform a particular operation or group of operations.

The communication unit 408 may include any component, device, system, or combination thereof that is configured to transmit or receive information over a network. In some embodiments, the communication unit 408 may communicate with other devices at other locations, the same location, or even other components within the same system. For example, the communication unit 408 may include a modem, a network card (wireless or wired), an optical communication device, an infrared communication device, a wireless communication device (such as an antenna), and/or chipset (such as a Bluetooth® device, an 802.6 device (e.g., Metropolitan Area Network (MAN)), a WiFi device, a WiMax device, cellular communication facilities, or others), and/or the like. The communication unit 408 may permit data to be exchanged with a network and/or any other devices or systems described in the present disclosure. For example, the communication unit 408 may allow the computing system 400 to communicate with other systems, such as computing devices and/or other networks.

Modifications, additions, or omissions may be made to the computing system 400 without departing from the scope of the present disclosure. For example, in some embodiments, the computing system 400 may include any number of other components that may not be explicitly illustrated or described. Further, the computing system may be included in other systems and/or contexts than those described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and methods described herein are generally described as being implemented in software (stored on and/or executed by general purpose hardware), specific hardware implementations or a combination of software and specific hardware implementations are also possible and contemplated.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A pedestrian alert signal system, comprising:
a pedestrian detector; and
a blank-out sign communicatively coupled to the pedestrian detector, the blank-out sign being configured to display, in response to receiving an indication of pedestrian detection from the pedestrian detector:
a pedestrian symbol, and
one or more directional crosswalk indicators positioned adjacent to the pedestrian symbol.

2. The pedestrian alert signal system of claim 1, wherein the pedestrian detector includes one or more of a pedestrian push button and a passive pedestrian detection device,
wherein the passive pedestrian detection device includes one or more of an image sensor, an infrared camera, a microwave radar, a piezoelectric pressure mat, and a light detection and ranging (LiDAR) sensor.

3. The pedestrian alert signal system of claim 1, wherein the blank-out sign includes a light-emitting diode (LED) array configured to generate the pedestrian symbol and the one or more directional crosswalk indicators.

4. The pedestrian alert signal system of claim 1, wherein the one or more directional crosswalk indicators include one or more of a top indicator, a bottom indicator, a left indicator, and a right indicator positioned relative to the pedestrian symbol.

5. The pedestrian alert signal system of claim 4, wherein the blank-out sign further includes a control system configured to selectively activate individual directional crosswalk indicators to indicate one or more crosswalks with pedestrian street crossing activity based on the indication of pedestrian detection from the pedestrian detector.

6. The pedestrian alert signal system of claim 1, wherein the pedestrian alert signal system is communicatively coupled to a traffic signal controller configured to control timing of a vehicular traffic signal.

7. The pedestrian alert signal system of claim 1, further comprising:
a communication module;
a processor; and
a memory configured to store instructions that, when the instructions are executed by the processor, cause the processor to send the indication of pedestrian detection from the pedestrian detector to the blank-out sign using the communication module.

8. A pedestrian alert apparatus, comprising:
a housing configured to couple to a traffic signal support structure;
a display panel disposed within the housing configured to generate, in response to receiving an indication of pedestrian detection:
a pedestrian symbol, and
one or more directional crosswalk indicators; and
a control interface configured to control generation of the pedestrian symbol and the one or more directional crosswalk indicators in response to receiving an indication of pedestrian detection.

9. The pedestrian alert apparatus of claim 8, wherein the indication of pedestrian detection is received from one or more of a pedestrian push button and a passive pedestrian detection device,
wherein the passive pedestrian detection device includes one or more of an image sensor, an infrared camera, a microwave radar, a piezoelectric pressure mat, and a light detection and ranging (LiDAR) sensor.

10. The pedestrian alert apparatus of claim 8, wherein the display panel includes a light-emitting diode (LED) array corresponding to the pedestrian symbol and the one or more directional crosswalk indicators.

11. The pedestrian alert apparatus of claim 8, wherein the one or more directional crosswalk indicators include one or more of a top indicator, a bottom indicator, a left indicator, and a right indicator positioned relative to the pedestrian symbol.

12. The pedestrian alert apparatus of claim 8, wherein the pedestrian alert apparatus is communicatively coupled to a traffic signal controller configured to control timing of a vehicular traffic signal.

13. A method, comprising:
receiving an indication of pedestrian detection from a pedestrian detector at a pedestrian alert apparatus; and
generating, based on the indication of pedestrian detection, one or more directional crosswalk indicators of the pedestrian alert apparatus,
the pedestrian alert apparatus being coupled to a traffic signal support structure.

14. The method of claim 13, wherein the pedestrian alert apparatus is positioned adjacent to a vehicular traffic signal coupled to the traffic signal support structure.

15. The method of claim 14, further comprising communicating with a traffic signal controller to coordinate timing of generating the one or more directional crosswalk indicators with timing of the vehicular traffic signal.

16. The method of claim 13, wherein receiving an indication of pedestrian detection includes one or more of:
pushing of a pedestrian push button,
image sensing,
thermal sensing,
microwave radar sensing,
pressure sensing, and
light detection and ranging (LiDAR) sensing.

17. The method of claim 13, wherein the one or more directional crosswalk indicators generated are based on one or more crosswalks detected to include pedestrian street crossing activity.

18. The method of claim 13, further comprising displaying a pedestrian symbol adjacent to the one or more directional crosswalk indicators.

19. The method of claim 13, wherein receiving the indication of pedestrian detection includes receiving the indication of pedestrian detection wirelessly via a communication module.

20. The method of claim 13, wherein generating the one or more directional crosswalk indicators includes illuminating a light-emitting diode (LED) array.
